(19) United States
(12) Patent Application Publication
(10) Pub. No.: US 2024/0306563 A1
(43) Pub. Date: Sep. 19, 2024

(54) COMPENSATED BURIED INFILTRATION IRRIGATION PIPE BELT WITH LAMINATED COMPOSITE TURBULENCE CHANNEL AND PROCESSING METHOD THEREOF

(71) Applicant: Shandong Changjiang Water-Saving Irrigation Tech Co., Ltd, Jinan City (CN)

(72) Inventors: Shiming MENG, Jinan City (CN); Xianwu MENG, Jinan City (CN); Juan DU, Jinan City (CN)

(73) Assignee: Shandong Changjiang Water-Saving Irrigation Tech Co., Ltd, Jinan City (CN)

(21) Appl. No.: 18/606,734

(22) Filed: Mar. 15, 2024

(30) Foreign Application Priority Data
Mar. 15, 2023 (CN) 202310258615.3

(51) Int. Cl. A01G 25/06

(52) U.S. Cl. CPC A01G 25/06

(57) ABSTRACT

Disclosed are a compensated buried infiltration irrigation pipe belt with a laminated composite turbulence channel and a processing method thereof, relating to the technical field of agricultural irrigation. The infiltration irrigation pipe belt structure includes an infiltration irrigation pipe belt body, multiple water outlet holes are uniformly formed in the infiltration irrigation pipe belt body, a thermal bonding layer is fixedly arranged outside the water outlet holes, a turbulence channel is formed at a joint of an inner wall of the thermal bonding layer and the water outlet holes, and water outlet ports communicating with the turbulence channel are formed at a side edge of the bonding layer.

### REFERENCE TO RELATED APPLICATIONS

This patent application claims the benefit and priority of Chinese Patent Application No. 202310258615.3, filed with the China National Intellectual Property Administration on Mar. 15, 2023, the disclosure of which is incorporated by reference herein in its entirety as part of the present application.

### TECHNICAL FIELD

The present disclosure relates to the technical field of agriculture irrigation, and in particular to a compensated buried infiltration irrigation pipe belt with a laminated composite turbulence channel, and a processing method thereof.

### BACKGROUND ART

With the gradual intelligentization of agriculture at present, the integration of water and fertilizer is required at first. In the past 30 years, China has achieved great success in water saving and fertilizer saving by using micro-irrigation. Nowadays, agricultural development has put forward higher requirements. Due to low utilization rate of water and fertilizer surface irrigation and short the service life of materials used for irrigation, repeated laying and replacement leads to resource waste and working time. In order to solve this problem, a buried infiltration irrigation mode can be adopted at present, the buried infiltration irrigation is water-saving, fertilizer-saving, land-saving, labor-saving, environment-friendly and yield-increasing. However, in the existing buried infiltration irrigation, it is easy to block the water outlet port due to soil, weeds and so on, thus affecting the irrigation effect.

### SUMMARY OF THE INVENTION

An objective of the present disclosure is to provide a compensated buried infiltration irrigation pipe belt with a laminated composite turbulence channel and a processing method thereof, so as to solve the problems in the prior art. The water outlet port is prevented from being blocked in the irrigation process by using a turbulence channel and a water outlet port structure.

To achieve the objective above, the present disclosure employs the following technical solution:

A compensated buried infiltration irrigation pipe belt with a laminated composite turbulence channel includes an infiltration irrigation pipe belt body, and multiple water outlet holes are uniformly formed in the infiltration irrigation pipe belt body. A thermal bonding layer is fixedly arranged outside the water outlet holes, a turbulence channel is formed at a joint of an inner wall of the thermal bonding layer and the water outlet holes, and water outlet ports communicating with the turbulence channel are formed at a side edge of the thermal bonding layer.

Alternatively, the thermal bonding layer includes a first sheet-like strip film fixedly pressed right above the water outlet hole, and one side, close to the water outlet hole, of the first sheet-like strip film is provided with the turbulence channel.

Alternatively, a side edge of the first sheet-like strip film is heat-sealed to the infiltration irrigation pipe belt body, and the water outlet port is formed in a heat-sealing position of the side edge of the first sheet-like strip film and the infiltration irrigation pipe belt body.

Alternatively, the turbulence channel is a dot-shaped mesh turbulence channel.

Alternatively, the thermal bonding layer includes a first sheet-like strip film, and a second sheet-like strip film. Each of the first sheet-like strip film and the second sheet-like strip film is provided with a turbulence channel, the first sheet-like strip film is fixedly pressed right above the water outlet hole, and the first sheet-like strip film is provided with a water outlet through hole. The second sheet-like strip film is attached to the first sheet-like strip film, area of the second sheet-like strip film is larger than that of the first sheet-like strip film, and a side edge of the second sheet-like strip film is provided with a water outlet port communicating with the turbulence channel.

Alternatively, the water outlet port is of a saw-toothed structure.

Alternatively, the water outlet through hole is located between two adjacent water outlet holes, and distances from the water outlet through hole to the two adjacent water outlet holes are equal. The water outlet port is located between two adjacent water outlet through holes, and distances from the water outlet port and the two adjacent water outlet through holes are equal.

A processing method of a compensated buried infiltration irrigation pipe belt with a laminated composite turbulence channel further provided by the present disclosure includes the following steps:
Step one, producing a drip irrigation pipe belt with a dripper using a plastic extruder, and enabling the drip irrigation pipe belt to enter a compound process after vacuum molding, punching and traction;
Step two, preparing a thermal bonding layer using a tape casting method, and pressing out a dot-shaped mesh turbulence channel on an inner side of the thermal bonding layer by an embossing roller; hot-pressing and bonding one face, with the turbulence channel, of the thermal bonding layer right above a water outlet hole of an infiltration pipe belt body by a hot-press wheel, and reserving heat-sealing edges on both sides of the thermal bonding layer, where a drip irrigation pipe belt with an embedded dripper is laminated and compounded by a first sheet-like strip film with a dot-mesh turbulence channel, and if compensation is not needed, there is no need to compound a second sheet-like strip film; and if compensation is needed, the second sheet-like strip film with a dot-mesh turbulence channel can be compounded after the first sheet-like strip film is compounded, thus playing a role of compensation, and the drip irrigation pipe belt compounded with two layers of sheet-like strip film also does not need the embedded dripper; and
Step three, heat-sealing saw-toothed water outlet ports to the heat-sealing edge using a press wheel with a saw-toothed opening; then pulling a finished product by a tractor, marking, and coiling the finished product into a bundle using a coiling reel.

Alternatively, the steps of compounding two layers of sheet-like strip films with dot-mesh turbulence channels in Step two include the following steps:
a first step, preparing a first sheet-like strip film using a tape casting method, pressing out a dot-shaped mesh turbulence channel on an inner side of the first sheet-like strip film by an embossing roller, and punching a water outlet through hole on the first sheet-like strip film, and hot-pressing and bonding one face, with the turbulence channel, of the first sheet-like strip film right above a water outlet hole of an infiltration pipe belt body by a hot-press wheel; and
a second step, preparing a second sheet-like strip film using the tape casting method, pressing out a dot-shaped mesh turbulence channel on an inner side of the second sheet-like strip film by the embossing roller, hot-pressing and bonding one face, with the turbulence channel, of the second sheet-like strip film right above a water outlet through hole of the first sheet-like strip film by the hot-press wheel, and reserving heat-sealing edges on both sides of the second sheet-like strip film.

Compared with the prior art, the present disclosure has the following technical effects:

According to the present disclosure, the water outlet hole is wrapped with a layer of thermal bonding layer with a turbulence channel, and a side edge of the thermal bonding layer is provided with a water outlet port communicating with the turbulence channel, thus preventing the problem that the water outlet hole, which makes direct contact with the land, is easily blocked by weeds and mud in the irrigation process. The saw-toothed water outlet cooperates with the turbulence channel structure leads to uniform discharge and stable and reliable flow rate. The design of the thermal bonding layer improves the overall strength of the pipe belt and prolongs the service life of the pipe belt.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a compensated buried infiltration irrigation pipe belt with a laminated composite turbulence channel according to the present disclosure;

FIG. 2 is a schematic diagram of a radial section of a compensated buried infiltration irrigation pipe belt with a laminated composite turbulence channel according to the present disclosure;

FIG. 3 is a partial enlarged diagram of a compensated buried infiltration irrigation pipe belt with a laminated composite turbulence channel according to the present disclosure;

FIG. 4 is a layout schematic diagram of a process line adopted by the present disclosure;

FIG. 5 is a schematic diagram of a secondary compounding machine according to the present disclosure.

In the drawings: 1—infiltration irrigation pipe belt body; 2—water outlet port; 3—thermal bonding layer; 4—turbulence channel; 5—principal machine; 6—vacuum molding box; 7—punching machine; 8—tractor; 9—secondary compounding machine; 10—winding machine.

### DETAILED DESCRIPTION

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a compensated buried infiltration irrigation pipe belt with a laminated composite turbulence channel and a processing method thereof, so as to solve the problems in the prior art. The water outlet port is prevented from being blocked in the irrigation process by using a turbulence channel and a water outlet port structure.

In order to make the objectives, technical solutions and advantages of the present disclosure more clearly, the present disclosure is further described in detail below with reference to the embodiments.

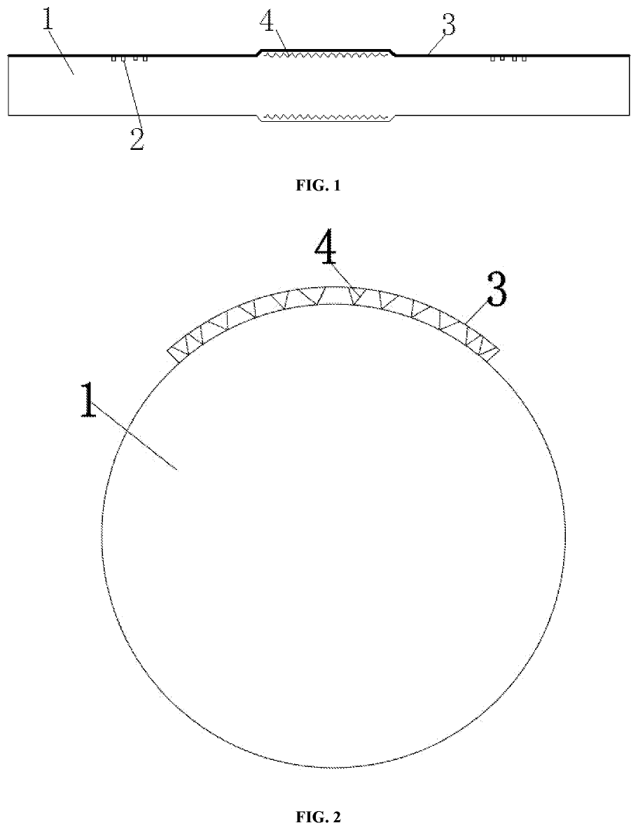

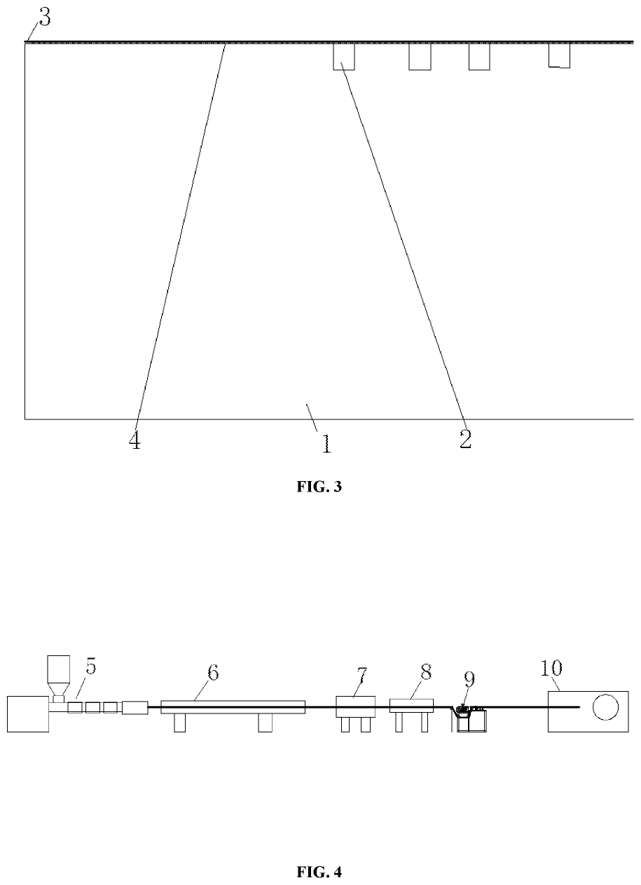

A compensated buried infiltration irrigation pipe belt with a laminated composite turbulence channel, as shown in FIG. 1, FIG. 2, and FIG. 3, includes an infiltration irrigation pipe belt body 1, and multiple water outlet holes are uniformly formed in the infiltration irrigation pipe belt body 1. A thermal bonding layer 3 is fixedly arranged outside the water outlet holes, a turbulence channel 4 is formed at a joint of an inner wall of the thermal bonding layer 3 and the water outlet holes, and water outlet ports 2 communicating with the turbulence channel 4 are formed at a side edge of the thermal bonding layer 3. According to the present disclosure, by providing the turbulence channel 4 located outside the water outlet hole, water in the drip irrigation pipe belt is free of making direct contact with the land after flowing out from the water outlet hole. When pressing edges are reserved on both edges of the thermal bonding layer after the turbulence channel is pressed out, an interval and gap meeting the discharge flow rate are reserved according to the requirement of the flow rate per meter of a designed drip irrigation pipe and belt, and a saw-toothed water outlet channel is reserved on a pressing wheel. In such a discharge way, the water outlet port is reserved on both sides, bonded to the drip irrigation pipe or the drip irrigation belt, of the thermal bonding layer, so the pipe and belt are uniform in discharge flow rate. The thermal bonding layer is compounded to protect the water outlet port from negative pressure suction for mud and plant root invasion, and thus the pipe/belt has strong blocking resistance, and the molded pipe/belt has the pressure compensation function.

In an embodiment, the thermal bonding layer 3 includes a first sheet-like strip film fixedly pressed right above the water outlet hole, and one side, close to the water outlet hole, of the first sheet-like strip film is provided with a dot-shaped mesh turbulence channel. A side edge of the first sheet-like strip film is heat-sealed to the infiltration irrigation pipe belt body, and the water outlet port is formed in a heat-sealing position of the side edge of the first sheet-like strip film and the infiltration irrigation pipe belt body. In this embodiment, a layer of sheet-like strip film is compounded outside the drip irrigation pipe belt, an inner side of the sheet-like strip film is provided with the dot-mesh turbulence channel, the turbulence channel structure is not specifically limited, and may be of other structures, as long as the design requirements can be satisfied. Saw-toothed water outlet ports are uniformly provided at both side edges of the strip film. Therefore, during the irrigation, compared with the traditional irrigation mode that the water directly flows out from the water outlet holes, the water flowing out from the water outlet holes finally flows out from the water outlet ports at both side edges after passing through the turbulence channel, the turbulence and pressure compensation functions are achieved. Moreover, the water outlet ports at the side edges are arranged obliquely with the drip irrigation pipe belt and communicate with the water outlet holes through the turbulence channel, thus preventing the water outlet holes from making direct contact with the soil, and playing a role of protecting the water outlet hole and preventing blockage. The turbulence effect of the turbulence channel can reduce the pressure of the water flowing out from the water outlet hole, and has good pressure compensation effect.

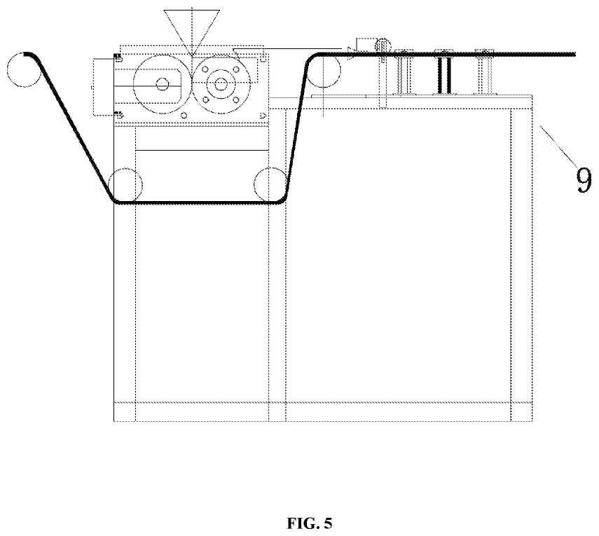

In this embodiment, a process line adopted by a processing method of the compensated buried infiltration irrigation pipe belt with a laminated composite turbulence channel is a mature production line, as shown in FIG. 4 and FIG. 5, mainly including a principal machine 5, a vacuum molding box 6, a punching machine 7, a tractor 8, a secondary compounding machine 9, and a winding machine 10. In this embodiment, the compounding of the thermal bonding layer is mainly achieved by means of the secondary compounding machine 9. The principal machine 5 includes an extruder. The method specifically includes the following steps:
Step one. A drip irrigation pipe belt with a dripper is produced using a plastic extruder, a tubular body with a cylindrical dripper or a patch dripper embedded therein is produced using one or two plastic extruders. The functions of the two extruders are mainly to use two different materials for compounding and molding, so as to create conditions for the next step of molding a thermal bonding with a dot-shaped mesh turbulent channel. For example, an inner layer of the drip irrigation pipe may be made of HDPE (high-density polyethylene), LDPE (low-density polyethylene), LLDPE (linear low=density polyethylene), a single material or a mixture, mainly to enhance compression resistance, softness and elasticity. EVA (ethyl vinyl acetate) compounded to an outer layer is mainly used to increase the elasticity and reduce the processing temperature. The temperature for extruding the HDPE and LLDPE out the pipe by an extruder is 190° C.-200° C., and the EVA material can be plasticized at 140° C.-150° C., and then the drip irrigation pipe belt enters a compounding process after vacuum molding, punching and traction.
Step two. A thermal bonding layer is prepared by a tape casting method, a plastic pipe-shaped or belt-shaped embedded cylindrical turbulence dripper or patch turbulence dripper molded by a machine head is extruded out by the plastic extruder; the embedded cylindrical turbulence dripper or patch turbulence dripper is molded by cooling and traction, and in front of the tractor of the drip irrigation pipe with the embedded cylindrical dripper or belt with embedded patch dripper, a sheet-like strip film is extruded by an extruder by the tape casting method; and a turbulent dot-shaped mesh strip film or other strip film with turbulence function designed according to the flow rate requirement required by the product is pressed out on one face, facing the drip irrigation pipe/belt, of the film by an embossing roller. One turbulent surface of the strip film with turbulent flow is hot-pressed and bonded right above the water outlet hole of the drip irrigation pipe belt by a hot-press wheel, the width and size of the dot-shaped mesh film strip is designed according to the diameter of the drip irrigation pipe belt, so as to completely cover the water outlet holes of the drip irrigation pipe/drip irrigation belt. Moreover, heat-sealing edges are reserved on both sides of the film strip. Besides a heat-sealing wheel, the drip irrigation pipe or drip irrigation belt is also heated by an oven. The oven temperature is about 100° C., which is beneficial to the linear velocity of pipe molding and the firm thermal bonding of the strip film with the turbulence channel to the drip irrigation pipe or drip irrigation belt.
Step three. When the pressing edges are reserved on both edges of the strip film after the turbulence channel is pressed out, an interval and gap meeting the discharge flow rate are reserved according to the requirement of the flow rate per meter of a designed drip irrigation pipe/belt, and a saw-toothed water outlet channel is reserved on a pressing wheel. In such a discharge way, the water outlet port is reserved on both sides, bonded to the drip irrigation pipe or the drip irrigation belt, of the thermal bonding layer, so the pipe and belt are uniform in discharge flow rate. The thermal bonding layer is compounded to protect the water outlet port from negative pressure suction for mud and plant root invasion, and thus the pipe/belt has strong blocking resistance, and the molded pipe/belt has the pressure compensation function. Afterwards, the finished product is pulled by the tractor, marked, coiled on a coiling reel to form bundles.

In another embodiment, in order to make the infiltration irrigation pipe belt firmer and have a longer service life, the inventor uniquely designed a thermal bonding layer structure, which changed the original thermal bonding layer 3 into a two-layer composite structure including a first sheet-like strip film and a second sheet-like strip film. An inner side of each of the first sheet-like strip film and the second sheet-like strip film is provided with a turbulence channel, the first sheet-like strip film is fixedly pressed right above the water outlet hole, the first sheet-like strip film is provided with a water outlet through hole, the second sheet-like strip film is attached to the first sheet-like strip film, the area of the second sheet-like strip film is larger than that of the first sheet-like strip film, and a side edge of the second sheet-like strip film is provided with a water outlet port 2 communicating with the turbulence channel. The water outlet through hole is located between two adjacent water outlet holes, and distances from the water outlet through hole to the two adjacent water outlet holes are equal. The water outlet port 2 is located between two adjacent water outlet through holes, and distances from the water outlet port 2 and the two adjacent water outlet through holes are equal. The first sheet-like strip film is made of EVA, the EVA is low in processing temperature and elastic. An EVA belt with the turbulence channel is hot-pressed on the first sheet-like strip film to play a role of pressure compensation. After the belt is pressed against the turbulence channel, the punching is required to form the water outlet through hole, and the hole can be punched mechanically or by laser. The punched belt is thermally bonded to the pipe or belt with the holes by the hot-press wheel, and the position of the water outlet through hole on the first sheet-like strip film needs to be set at 50% of the position of the water outlet hole bonded to the drip irrigation pipe belt, in this way, the turbulence effect is good, and the large gap between the turbulence channel is beneficial to blocking resistance. The second sheet-like strip film, after the turbulence channel on the belt is pressed out by the embossing roller, is thermally bonded and compounded on the first sheet-like strip film and the drip irrigation pipe belt by a heat-sealing wheel, the heat-sealing edge is larger than that of the first sheet-like strip film, and the second sheet-like strip film should be designed with a sawtooth-shaped water outlet port. The realization of the water outlet 2 is that a saw-toothed opening is reserved on the heat-sealing wheel, and the water outlet port 2 is formed without heating the drip irrigation pipe belt below during heat-sealing, and the position of the water outlet 2 should be adjusted to the position at 50% of the water outlet through hole of the first sheet-like strip film. Therefore, the water flow distance is longer, and the water flow can pass through turbulence of two layer of strip film, making the turbulence effect better. Moreover, the second strip film, after the turbulence channel on the belt is pressed out by the embossing roller, is thermally bonded and compounded on the first sheet-like strip film and the drip irrigation pipe belt by a heat-sealing wheel, the heat-sealing edge is larger than that of the first sheet-like strip film, and the heat-sealing edge is larger than that of the first strip film, thus preventing the water from leaking directly through the first strip film.

In this embodiment, a processing method of a compensated buried infiltration irrigation pipe belt with a laminated composite turbulence channel includes the following steps:
Step one. A pipe or belt is extruded by a plastic extruder, water holes are punched in a molded pipe or belt, i.e., a drip irrigation pipe belt, at intervals determined according to different requirements of water discharge flow rate per meter. In front of the molded plastic pipe or belt tractor, a strip-shaped belt is extruded by one plastic extruder, and a dot-shaped mesh turbulence channel is pressed out by an embossing roller to form the first sheet-shaped strip film. The first strip film material is made of EVA with low temperature and elasticity. An EVA belt with the turbulence channel is hot-pressed on the first sheet-like strip film to play a role of pressure compensation. After the belt is pressed against the turbulence channel, the punching is required to form the water outlet through hole, and the hole can be punched mechanically or by laser. The punched first sheet-like strip film is thermally bonded to the pipe or belt with the holes by the hot-press wheel, and the position of the water outlet through hole on the first sheet-like strip film needs to be set at 50% of the position of the water outlet hole bonded to the drip irrigation pipe belt, in this way, the turbulence effect is good, and the large gap between the turbulence channel is beneficial to blocking resistance.
Step two. After the first sheet-like strip film is compounded and molded, a plastic extruder is added in front of the tractor to extrude a second sheet-like strip film. The second sheet-like strip film is made of a mixture of HDPE and LLDPE, which are according to the hardness, strength and tensile strength of the second sheet-like strip film, the ratio of the HDPE to the LLDPE is generally 4:6. The extruded belt, after the turbulence channel on the second sheet-like strip film is pressed out by the embossing roller, is thermally bonded and compounded to the first sheet-like strip film and the drip irrigation pipe belt by the heat-sealing wheel. The heat-sealing edge should be larger than that of the first sheet-like strip film, and the second sheet-like strip film should be designed with a saw-toothed water outlet port. The realization of the water outlet port is that a saw-toothed opening is reserved on the heat-sealing wheel, and the water outlet port 2 is formed without heating the lower pipe and belt during heat-sealing, and the position of the water outlet port 2 should be adjusted to a position at 50% of the two water outlet through holes of the first sheet-like strip film.
Step Three. The drip irrigation pipe belt, after being laminated and compounded, is pulled by a tractor, marked, and then coiled on a reel wheel at 500 m for each coil of pipe and 200 m for each coil of belt, or coiled, bundled and inspected according to the requirements of the customer, and then is put into storage.

The present disclosure mainly solves the problem that drip irrigation pipe and belt cannot be buried inside and outside and are blocked, has the advantages of online one-time production and molding, high production efficiency, effectively reduced production cost, automatic production, less labor, capability of using high-quality plastic recycled materials, advanced product design structure, uniform and stable water flow, pressure compensation, longer pipeline laying, reduced project construction cost, strong blocking resistance, and long service life of products.

The design structure and production technology of the product solve the process of high-priced mold injection matching parts needed by other production methods to produce buried infiltration irrigation pipe belts, and the change of the specification and diameter of the molded pipes/belts can be realized quickly and easily during production and molding, thus reducing the cost of production device investment.

The present disclosure is an important technical breakthrough of agricultural water-saving products, and this technology is advanced in China and at abroad. The laminated composite turbulence channel infiltration pipe can also eliminate the embedded dripper, which breaks the routine of producing the drip infiltration pipe/belt in the past. By adopting buried infiltration irrigation products and technologies, the integration of water, fertilizer, medicine and gas is achieved, which can make great contributions to the increase of grain production, the reduction of carbon in agriculture, the non-point source pollution of fertilizer, the soil improvement, water resource saving, and the realization of agricultural intelligent modernization in China.

In the description of the present disclosure, it needs to be understood that the orientation or positional relationship indicated by terms “center”, “top”, “bottom”, “left”, “right”, “vertical”, “horizontal”, “inside” and “outside” is based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. Furthermore, the terms “first” and “second” are used for descriptive purposes only and are not to be construed as indicating or implying relative importance.

Specific examples are used herein for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

1. A compensated buried infiltration irrigation pipe belt with a laminated composite turbulence channel, comprising an infiltration irrigation pipe belt body, and a plurality of water outlet holes are uniformly formed in the infiltration irrigation pipe belt body; a thermal bonding layer is fixedly arranged outside the water outlet holes, a turbulence channel is formed at a joint of an inner wall of the thermal bonding layer and the water outlet holes, and water outlet ports communicating with the turbulence channel are formed at a side edge of the thermal bonding layer.

2. The compensated buried infiltration irrigation pipe belt with a laminated composite turbulence channel according to claim 1, wherein the thermal bonding layer comprises a first sheet-like strip film fixedly pressed right above the water outlet hole, and one side, close to the water outlet hole, of the first sheet-like strip film is provided with the turbulence channel.

3. The compensated buried infiltration irrigation pipe belt with a laminated composite turbulence channel according to claim 2, wherein a side edge of the first sheet-like strip film is heat-sealed to the infiltration irrigation pipe belt body, and the water outlet port is formed in a heat-sealing position of the side edge of the first sheet-like strip film and the infiltration irrigation pipe belt body.

4. The compensated buried infiltration irrigation pipe belt with a laminated composite turbulence channel according to claim 2, wherein the turbulence channel is a dot-shaped mesh turbulence channel.

5. The compensated buried infiltration irrigation pipe belt with a laminated composite turbulence channel according to claim 1, wherein the thermal bonding layer comprises a first sheet-like strip film, and a second sheet-like strip film; each of the first sheet-like strip film and the second sheet-like strip film is provided with a turbulence channel, the first sheet-like strip film is fixedly pressed right above the water outlet hole, and the first sheet-like strip film is provided with a water outlet through hole; the second sheet-like strip film is attached to the first sheet-like strip film, area of the second sheet-like strip film is larger than that of the first sheet-like strip film, and a side edge of the second sheet-like strip film is provided with a water outlet port communicating with the turbulence channel.

6. The compensated buried infiltration irrigation pipe belt with a laminated composite turbulence channel according to claim 5, wherein the water outlet port is of a saw-toothed structure.

7. The compensated buried infiltration irrigation pipe belt with a laminated composite turbulence channel according to claim 5, wherein the water outlet through hole is located between two adjacent water outlet holes, and distances from the water outlet through hole to the two adjacent water outlet holes are equal; the water outlet port is located between two adjacent water outlet through holes, and distances from the water outlet port and the two adjacent water outlet through holes are equal.

8. A processing method of a compensated buried infiltration irrigation pipe belt with a laminated composite turbulence channel, comprising the following steps:
Step one, producing a drip irrigation pipe belt with a dripper using a plastic extruder, and enabling the drip irrigation pipe belt to enter a compound process after vacuum molding, punching and traction;
Step two, preparing a thermal bonding layer using a tape casting method, and pressing out a dot-shaped mesh turbulence channel on an inner side of the thermal bonding layer by an embossing roller; hot-pressing and bonding one face, with the turbulence channel, of the thermal bonding layer right above a water outlet hole of an infiltration pipe belt body by a hot-press wheel, and reserving heat-sealing edges on both sides of the thermal bonding layer; and
Step three, heat-sealing saw-toothed water outlet ports to the heat-sealing edge using a press wheel with a saw-toothed opening; then pulling a finished product by a tractor, marking, and coiling the finished product into a bundle using a coiling reel.

9. The processing method of the compensated buried infiltration irrigation pipe belt with a laminated composite turbulence channel according to claim 8, wherein Step two comprises:
a first step, preparing a first sheet-like strip film using a tape casting method, pressing out a dot-shaped mesh turbulence channel on an inner side of the first sheet-like strip film by an embossing roller, and punching a water outlet through hole on the first sheet-like strip film, and hot-pressing and bonding one face, with the turbulence channel, of the first sheet-like strip film right above a water outlet hole of an infiltration pipe belt body by a hot-press wheel; and
a second step, preparing a second sheet-like strip film using the tape casting method, pressing out a dot-shaped mesh turbulence channel on an inner side of the second sheet-like strip film by the embossing roller, hot-pressing and bonding one face, with the turbulence channel, of the second sheet-like strip film right above a water outlet through hole of the first sheet-like strip film by the hot-press wheel, and reserving heat-sealing edges on both sides of the second sheet-like strip film.
